(19) United States
(12) Patent Application Publication
(10) Pub. No.: US 2007/0185794 A1
(43) Pub. Date: Aug. 9, 2007

(54) Method and system for finance, distribution and speculation

(76) Inventors: Timothy Maxwell Keiser, West Hollywood, CA (US); Matthew Lederman, New York, NY (US)

Correspondence Address: MARC E. HANKIN, ESQ., 11414 THURSTON CIRCLE, LOS ANGELES, CA, 90049, US

(21) Appl. No.: 11/338,921

(22) Filed: Jan. 23, 2006

(51) Int. Cl. G06Q 40/00

(52) U.S. Cl. 705/35

(57) ABSTRACT

This invention discloses a method and system that allows individuals to finance and speculate on the success of films and various other projects on the internet. According to the invention, Producers transmit a project offering using an internet-enabled device to a System website, and the System accepts bids from Consumers for the offering. With this invention, Producers and Consumers arrive at mutually acceptable revenue splits for these projects.

### FIELD OF INVENTION

This invention relates, generally, to a method and system for financing and distributing digital media projects by enabling producers, acting as their own agents or otherwise, a way to offer future product, as well as future revenue participation, to consumers, who in turn act as financiers, distributors, and speculators, using an innovative primary auction system and speculative secondary markets.

### BACKGROUND

Historically, speculating on projects, such as film, music, and video games, has been limited to corporate investors and wealthy private individuals. The extreme and uncertain risks of these projects include: production delays, cost overruns, questionable accounting practices, unsatisfactory production values, and uneven sales, or box office failure. In addition, given the limited sources of financing for producers, and the spiraling costs for talent, equipment, and materials, it is not surprising that independent producers in particular are at a competitive disadvantage.

Consumers too have also been disadvantaged. The difficulty that independent producers face raising funds combined with the entrenched and risk adverse nature of large and well funded entities combines to deprive consumers of choice of content in the marketplace.

Investment firms also market pools of dedicated film-finance capital and some hedge funds also invest in film finance thus making investments in film products accessible to the public. For instance, several investment houses, such as J. P. Morgan, are offering funds that will raise several hundred million dollars that will be used to finance half the production and marketing budget for major studio films. However, one problem with such financing schemes is that the individual investors have little or no choice in which films are funded. Moreover, in some cases, the movie studios may allocate the fund money to riskier projects, while concentrating its own capital to franchise films with a proven record of success. These hedge funds and investment pools can also have the effect of increasing the inflationary pressures that are forcing up talent costs, thereby making the job of raising money for independent productions even more difficult. Additionally, these schemes are classified as “investments” so they are bound by costly, time consuming government regulations.

The Internet is being used for a number of commercial purposes, including enabling members of the public to participate in film financing. One such website, maintained by moviesforthemasses.com, asks internet visitors to contribute at least $1.00 toward any of a list of movie synopses, promising to put the money into the designated film, and in return for this $1.00 give every donor credit as an Executive Producer. Another website, run by civilian.com, offers private placement investment opportunities in special purpose companies, formed specifically to produce feature films. However, this site requires a minimum investment of $1,000 to invest and does not allow consumers to influence which films get made.

The Internet also offers opportunities for objects, possibly including digital media projects, to be auctioned off. Several auction websites are available, such as Ebay and Yahoo, which describe or display the object to be auctioned and details such as name, address, and payment instructions in the event of a successful bid. Using these websites, bids are received by the web site and the bidder whose bid is the highest at the termination of the auction (the “successful bidder”) becomes the purchaser of the item. Another web site, bidnation.co.uk, has a system in which the lowest unique bid wins the item to be auctioned. However, the shortcoming of such auction websites for auctioning projects such as films, music, and video games is that they do not take into account the ever changing nature of the project, one that progress through several cycles of evolution before being eventually transformed into a finished product. Another shortcoming of these auction websites is that they make no accommodation for negotiations to take place between producers, who are willing to offer royalty income to consumers, and consumers who are willing to provide funding either in the form of investment, or pre-orders of the finished product.

A need exists to expand the universe for individuals and entities to have an opportunity to participate in the financing of digital media projects. Still further, a need exists for the provision of mechanisms for hedging, in whole or in part, the substantial investment in these production, promotion and distribution of such projects. This mechanism can be affected by providing independent producers and consumers a way to align their interests; to bypass existing corporate infrastructure, and to exploit the Internet's end-to-end architecture all of which will simultaneously reduce audience-rejection risk by involving consumers as financiers, distributors and speculators during the inception stage of a project's life.

Furthermore, there has been a long felt need for a method that aligns the interests of producers and consumers during a project's inception stage, when a project's audience-rejection risk is at its lowest, while simultaneously obviating the need for costly agents, creative executives and other inefficient entertainment industry layers that inflate costs. There has been a need to accomplish this result with a method and system that does not require any governmental oversight.

### SUMMARY OF THE INVENTION

This invention is directed towards overcoming the above shortcomings by disclosing a method and system that allows individuals to finance and speculate on the success of films and various other projects on the internet.

In one embodiment, the method in accord with the invention comprises creating a DUO for a project on a System, processing of the DUO by a System Administrator, displaying of the DUO by the System, aligning of interests for a plurality of DUs of the project, associated with the DUO, by a Producer and a Consumer, and closing of an auction for the plurality of DUs of the Project by the System Administrator.

In another embodiment, the method in accord with the invention comprises creating a DUO for a project on a System, processing of the DUO by a System Administrator, displaying of the DUO by the System, aligning of interests for a plurality of DUs of the project, associated with the DUO, by a Producer and a Consumer, and closing of an auction for the plurality of DUs of the Project by the System Administrator, and listing of a plurality of DU components by Consumer on a Secondary Market System.

In a further construction, the system in accord with the invention comprises an internet-based information component connected to the internet for creating a DUO for a project on a System, processing of the DUO by a System Administrator, displaying of the DUO by the System, aligning of interests for a plurality of DUs of the project, associated with the DUO, by a Producer and a Consumer, closing of an auction for said plurality of DUs of the Project by the System Administrator, and listing of a plurality of DU components by Consumer on a Secondary Market.

In a further construction, the system in accord with the invention is further configured so that the DUO is comprised of a credit, coupon and auxiliary component.

The foregoing, and other features and advantages of the invention, will be apparent from the following, more particular description of the preferred embodiments of the invention, the accompanying drawings, and the claims.

### BRIEF DESCRIPTION OF THE DRAWINGS

FIG. 1 is a block diagram showing one embodiment of the invention's hardware.

FIG. 2 is a flow chart showing the life cycle of a project.

FIG. 3 illustration of a screen-shot from the System site for entering Project details

FIG. 4 illustration of a screen-shot from the System site showing System Administration's calculated estimates for Project.

FIG. 5 illustration of a screen-shot from the System site showing various entry fields.

FIG. 6 illustration of a screen-shot from the System site showing a lists of available projects.

FIG. 7 illustration of a screen-shot from the System site showing a transaction for form.

### DETAILED DESCRIPTION OF THE DRAWINGS

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of embodiments of the invention.

This invention is directed to a method and system that allows producers to finance projects by selling offerings containing separable components including, but not limited to, credits for future deliverables such as downloads; coupons in which value is tied to possible future revenue streams;, and auxiliary goods, and services to consumers who agree to purchase these offerings in sufficient quantities. This invention also provides for the distribution of the deliverable contents of these offerings upon completion. Furthermore, this invention allows for the contents of these offerings to be bought, sold or exchanged on one or more secondary markets maintained by the system for a length of time that may be specified as part of the offering.

Definitions

The following terms are used herein to refer to the following:

The System: a web application which also includes the software and hardware.

Project: the entire work or any part of a work that needs financing.

Project Category: the type of project, including, but not limited to, films, video and computer games, and musical recordings, as well as the various stages of development of a project, such as but, not limited to, script, development, principal photography in progress, and post-production.

System software: a plurality of software used by the System.

Primary Auction/‘Allied Auction’ component: a System component of deferring transactions between prospective consumers and finance-seeking producers where transactions are not completed until a satisfactory revenue sharing arrangement has been negotiated between Producers and Consumers. During this process the price of the object being auctioned remains constant while the content of the object (i.e., the digital media project) itself varies.

Deal Unit (DU)/Presale Unit: A unit used by the System that is comprised of one or more separable components, including but not limited to, credits for future deliverables (hereinafter referred to as Credits) which in many cases can be a download; revenue coupons (hereinafter referred to as Coupons) whose rate of interest is determined as the objective of the Primary Auction process used to raise the funds necessary to finance a project, and auxiliary goods or services (hereinafter referred to as Auxiliaries), for example, tee shirts or roles in the production. Once funding is complete, the DU splits into its component parts within the Consumer Portfolios in which the DU is held. Unused Credits can be traded via the secondary market maintained by the System. Coupons too can be traded on the Secondary Market maintained by the System.

Unsecured-DU: DU selected by Consumers can be held, released or exchanged for other DUs at any time by the Consumer until the 100% or a value more than 100% (value to be determined by the System Administrator) of any DU have been fully subscribed.

Secured DU: Once 100% or a value more than 100% of a DU for any particular Project have been fully subscribed, then the Primary Auction is closed by the System Administrator and unsecured DUs become secured-DUs.

Secondary Market component: A component of the System that allows Consumers to buy and sell Coupons and Credits components of the DU, after the DU has been separated in the Consumer's Portfolios. The Secondary Market also allows for the sale of non-DU-based deliverables.

Closing of the Primary Auction: Once 100% or a value more than 100% of a DU for any particular Project has been fully subscribed, the Primary Auction is closed by the System Administrator.

Deal Unit Offering (DUO) is an open document that is constantly being updated by the producer as conditions change during the conception and development stages of their projects; including changes in the System market as the supply and demand for various other projects listed on the System influence the relative marketability of all projects. The DUO contains a description of the Project, comprising details of the Project (including, but not limited to, synopsis, talent, time frame, terms), its financing requirements, and details of its DU components. The amount of Project detail provided by the Producer to the System Administrator can be as minimal as a rumor, or as comprehensive as a completed Project that is seeking marketing or distribution. DUOs are constantly being updated by the Producers, via password protected access, in order to compete effectively with other Projects offered on the System. Producers are responsible for the accuracy of this information; including but not limited to financing objectives, details of the detachable coupon including time constraint. The Project detail is the counterpart within the system to the Consumer's Portfolio and both are at the heart of the Primary Auction methodology.

Producer or Producer-Agent: any person or entity attempting to raise funds for a project in any category or any stage of development using the Primary Auction system in exchange for financing and distribution; or any person or entity offering finished digital media products for sale.

Consumer (used interchangeably with Consumer-Financier-Distributor-Speculator): any person or entity acquiring DUs to finance a Project; any person or entity acquiring deliverables after the completion of a Project; or any person or entity buying, selling, or otherwise trading components of DUs.

Portfolio: data in the system maintained by individual consumers who are participating in an unlimited number of Primary Auctions, updated continuously to reflect both the actions of the Producers (whose Projects are being auctioned) and Consumers (whose aggregate interest determines the terms of royalty coupons being shared by the Producers with the Consumers) up until such time as an auction is closed. The data contained in this Portfolio can be accessed as a web page on the System by the Consumer.

Coupon: component of the DU that represents a portion of a revenue steam. The coupon consists of a revenue stream identifier, such as worldwide download revenue, a percentage (from 0%-100%), and an optional time constraint. The variable rate component of the DU represents a pro-forma portion of a revenue stream determined during the Primary Auction process.

Credit/DU-based credit: portion of the DU that represents a future deliverable object. For instance, the Credit for a film, video/computer game, or music Project can be the download version of the film/game/music.

Non-DU-based credit: finished versions of the media projects that can be purchased (and typically downloaded) by Consumers on the Secondary Market without Consumers having to buy the Project DU.

System Administrator: a computer program and/or a human operator, who performs a plurality of administrative functions for the System.

Ancillary Coupons: any additional coupon deals attached to Projects that have revenue streams other than world wide downloads, including but not limited to revenue from box office, foreign sales, and television sales.

Auxiliary Credit: component that represents the right to goods and services that are not the main credit deliverable financed by the DU. These Auxiliary Credits may be traded among Consumers in Secondary Market maintained by the System. For instance a completed digital media Project not a component of a DU can be an Auxiliary Credit that is available on the System. Sales of Auxiliary Credits result in revenue splits negotiated during the Primary Auction; minus the System fee, for example 10%.

Swap Value of extra Credits: A value determined by the System Administrator when the Consumer has more Credits in their Portfolios than they have use for. These Credits may be exchanged in a Secondary Market maintained by the System.

The Hardware

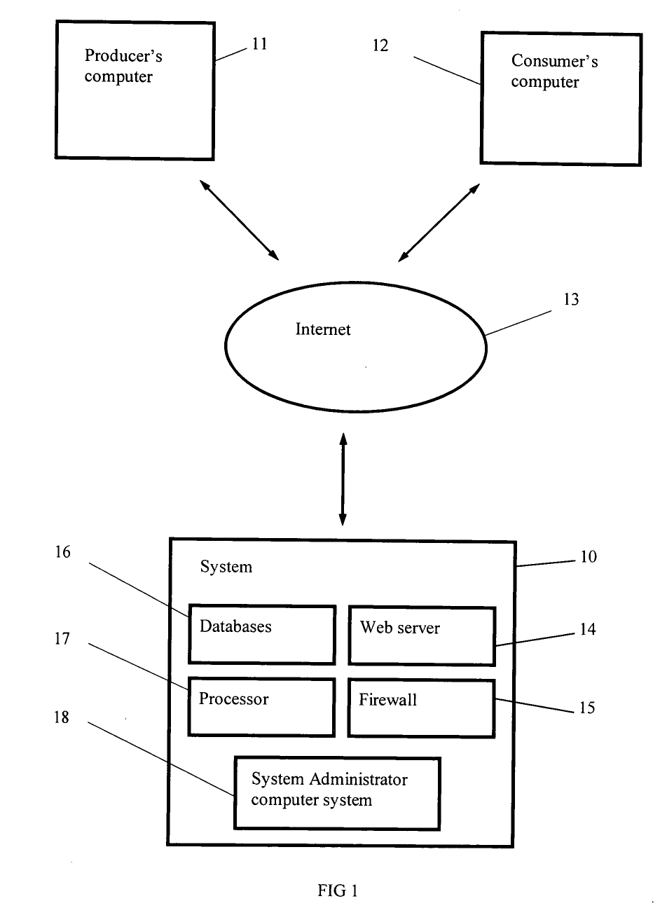

According to one construction in FIG. 1, Producer 11 and Consumer's 12 computers are linked to the System 10 via the internet (or World Wide Web), and include web browsers and a web document. The web browsers comprise software programs configured to enable the Producer and Consumer to access files from their computer which are connected with the Internet 13.

The System 10 comprises a web server 14, a firewall 15, one or more databases 16, one or more processors 17, and a System Administrator computer system 18 (See FIG. 1). For purposes of this disclosure, the term “web server” is understood to include one or more computers located at one or more physical locations and having a hardware component that serves code and data to the web. The web server computer has a software program that receives, manages, and responds to requests for documents and files. It is understood that web server's computer, as well as the Producer and Consumer's computers include one or more CPUs, hardware such as one or more data storage devices, such as a hard disk drive (HDD); memory, such as random access memory (RAM); interface devices, such as a display screen, keyboard, and/or a tactile input device; and a web site. All the computers operate under the control of an operating system, such as Windows, Macintosh, UNIX, etc. A firewall 15 is present which provides security between the computers and the internet.

The System web site is viewable by the Producer or Consumer with a web browser or any software or delivery system that is used to view electronic content, and includes a database and one or more web pages. The web pages allow the System Administrator, Producer, and Consumers to submit and obtain information related to the Project. These web pages comprise electronic pages or documents that include text and/or graphics, audio, video, and/or other dynamic media. For purposes of this disclosure, individual web pages can be active and include “hot buttons”, “clickable icons”, and/or “links” which will also be referred to hereinafter as “triggers”. Triggers enable the launching of a simple application-software program and/or access to linked pages. There are also triggers that allow the Consumer to request assistance from the System Administrator.

It is understood that the database within the web site includes a collection of inter-related and/or non-related data including links (including web links) that are stored together on the web server computer database. However, in one embodiment of the invention access to certain pages are restricted solely to the System Administrator, the Producer or the Consumer. Further, these links allow Producers and Consumers to search their own records and access other independent information sources related to the Project.

Other than using desk-top or lap top computers, Producers and Consumers can also use wireless web appliances to remotely communicate with the System over the Internet by entering the appropriate electronic address. It is understood that the wireless web-enabled appliance can be a telephone, an electronic organizer, and any of a number of types of computers, or any other device capable of displaying computer-generated information on a screen. However, Producers and Consumer should have software installed to send and receive secure e-mails and documents from the System. The System will also require usernames, passwords and verifiable e-mail addresses for security purposes. It will be appreciated that the System is also reachable using telephone, voice recognition devices, and mail systems.

It is understood to those skilled in the art that the exemplary hardware environment described above is not intended to limit the present invention. Moreover, it should be understood that other alternative hardware environments may be used without departing from the scope of the present invention.

The System Administrator

The System Administrator is an entity that has many functions, some of which are listed below:

First, the System Administrator sets the charge, other than in exchange for a credit received as part of a DU, that is collected by the System when downloads are sold to Consumers. This charge can be a percentage that can vary from 0% and upward,(i.e., 10%) However, this charge can also be a flat fee or a formula.

Second, the System Administrator processes the DUO information created by the Producers. As part of this process, the system administrator rates the producer involved (using a ranking system from AAA-F as well as unrated), estimated film-rating board designation (G, PG, R, NC-17), as well as other variables tracked. The System Administrator may be required to re-assess these ratings after the Producer reviews and decides to update his DUOs during the course of the Primary Auction process. These System Administrator ratings are continuously reviewed by Consumers, as well as Producers, as Projects get closer to their ultimate funding goals. To maximize the System Administrator's efficiency in managing the System, database applications can be customized so that the System Administrator can focus their attention on Projects that have, for example, the highest percentage of required finance requirement, or ‘DU-interest ratio’ at any given time.

The third job of the System Administrator is to assist the Producers during the creation process (if they so require) in working out the details of a possible royalty-share agreement with Consumers for these film Projects. The exact terms of the royalty-share can change at any time, and it is these changes that attract Consumers to buy any given Project DU. These changes in royalties (as well as changes in the any other movie production variables) are instantly displayed by the System Server to Consumers at any given time. Royalties for a particular Project are, however, not a requirement for listing a Project on the System. Nevertheless, royalties can give a Project a competitive edge in the race to raise money for films by attracting more interest from Consumers. By offering Consumers some participation in future royalties, Producers can, in effect, buy allegiance to a paid-download model such as in this invention because the Consumers are, in effect, partnering with the Producers with a potential upside being tied to the popularity of the Projects that the Consumers have, in effect, ‘green lighted’ with their purchases of DUs.

The fourth job of the System Administrator is to assist Producers in the DUO creation process to work out the details of any ancillary coupon deals, as might be the case of multiple coupons offered as part of a DUOs related to the same project; that have potential revenue streams to share with consumers. In such cases, the System Administrator will also figure out a projected blended royalty income per Deal Unit percentage per paid download number and display this number.

The fifth job of the System Administrator is to play the role of market maker in the system, making sure any Consumer looking to add or subtract DUs to their portfolio can do so from the ready supply of DUs held in the master portfolio of the System Administrator until such time as all DUs for a project are pre-bought. The System Administrator can buy and sell DUs for its own portfolio if it wishes to speculate in various projects. (with the caveat of making sure consumers have adequate access to DUs ahead of any orders placed by the System Administrator for its own master portfolio).

The sixth job of the System Administrator is to serve as paymaster. For example, the System Administrator is responsible for dispersing weekly payments from the pool of money collected upon completion of a successful Primary Auction to the Project's Producer over the production period.

The seventh job of the System Administrator is to make sure the Project (that is, films, games, music) Credits are available for delivery (i.e., download) to the Consumers who bought the DUs in a timely manner.

The eighth job of the System Administrator is to track and periodically distribute any royalty income to the DU coupon holders directly into the Consumer Portfolios, or otherwise.

The ninth job of the System Administrator is to maintain the master price for all DUs and non DU-based downloads on the system. In this way, the System Administrator can affect the overall economy of the System in ways that make it possible to compete with other systems in the content provision industry, as well as helping to manage the internal economics of the system itself where considerations of money entering and leaving the system may impact.

When a System administrator changes the price for all DUs in the System, only DUs for projects that have not been locked (that is, less than 100% of the available units have been ordered) are affected. There are two ways in which the affected DU offerings can be modified by changing the price. In the first way, the number of DUs available is changed in inverse proportion to the price change resulting in the same amount of funding for the project. In the second, the number of DUs is unchanged, resulting in a directly proportional change in the amount of funding sought. If the number of DUs is changed, the System has the option of changing the number ordered in Consumer accounts proportionally or leaving the number unchanged. The Consumer has the ability to return any or all ordered units any time up until the DU offering is locked.

The tenth job of the System Administrator is to manage the project financing fee rate. This percentage can be varied by the System Administrator for both the entire system as a whole and for individual Projects, depending on risk metrics and other information associated with various Projects. This rate can also be a constant, or formula determined by the System Administrator.

The eleventh job of the System Administrator is to help the Producer create one or more deal unit offerings (DUO's) on the System with or without the aid of the software wizard.

The twelfth job of the System Administrator is to manage the master ‘green show’ percentage applying to all Primary Auctions where it may be necessary to allow for ‘bad faith’ on the part of Consumers who fail to make good on their pre-purchases when such transactions are invoiced.

The thirteenth job of the System Administrator is to determine the Swap Value of extra Credits for deliverables, such as downloads, that accumulate in Consumers'Portfolios as a result of speculation in coupons. When the Consumer has more deliverable credits in their Portfolios than they have use for, these credits may be exchanged in a secondary market maintained by the System at the Swap Value determined by the System Administrator.

The fourteenth job of the System Administrator is to charge a fee for after-market downloads, which is a variable fee set against the economic needs of the system as a whole, or various ‘subscription’ considerations.

The fifteenth job of the System Administrator is to determine the number of Unsecured-DUs Consumers may hold in their portfolios and require them to secure these holdings with a fee, or subscription of some kind.

The sixteenth job of the System Administrator is to determine the commission rate in Secondary Market for coupons per the needs of the economy as a whole; and/or determine fee and subscription considerations.

The Process as a Whole

The Primary Auction System as a whole maintains a dynamic, continuous market where there are potentially an unlimited number of DUs. The Primary Auction System is an economy based on Consumer participation in the creation of media projects that reflect the interests of the whole representative community. Here, Producers and Consumers arrive at a mutually acceptable, pro-rated fractional interest in a Project.

The process starts with a Producer seeking to finance his Project. Using the System's Primary Auction process the Producer is able to finance the whole or any part(s) of his Project(s). In the Primary Auction process, as disclosed in this application, both the Producer side and the Consumer side of the auction align their interests for a mutually beneficial outcome and in doing so help create and then modify the Project in the auction. As will be evident, the System achieves this with the coupon concept attached with a Project DU.

Creation of a Project on the System

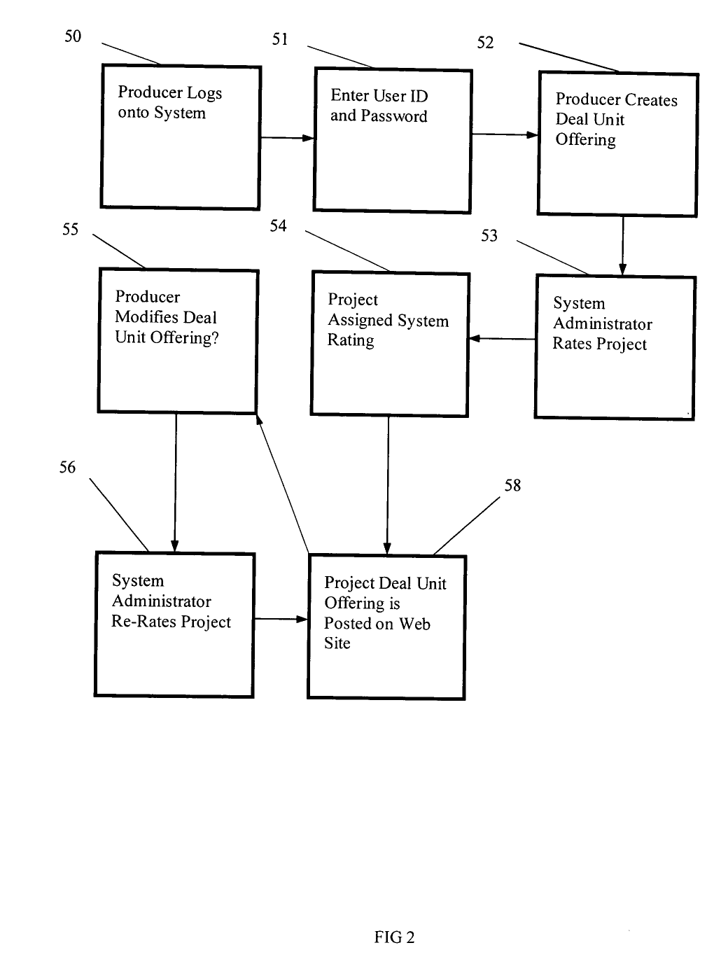

In one embodiment of the invention as shown in FIG. 2, the Producer logs onto the System 50, entering his or her user id/password 51, and begins to create his DUO by completing a DUO application page 52. In this process (see below) the Producer enters various details of his Project such as, but not limited to, a description of the Project, creative elements attached such as the DUO, the amount of money the Producer is looking to raise, and any future royalties they s/he may/or may not be willing to share via the coupon that comes embedded in each DUO.

A Producer lists a project on the System using a simple software function called a “wizard” that simplifies the process by configuring DU consisting of a deliverable, in this case a credit for a download of the finished project after completion, and a coupon, in this case a percentage of the worldwide download sales revenue.

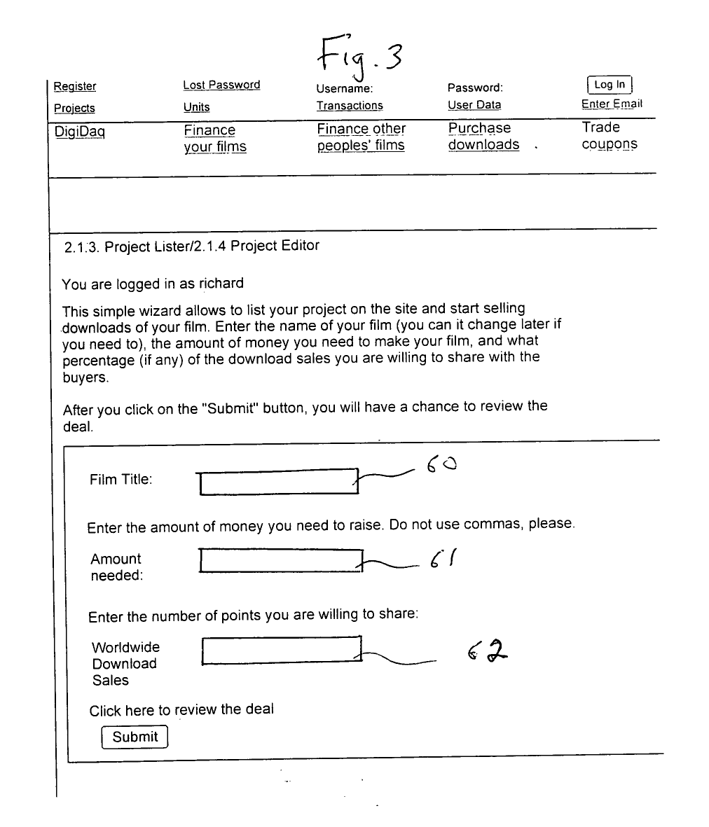

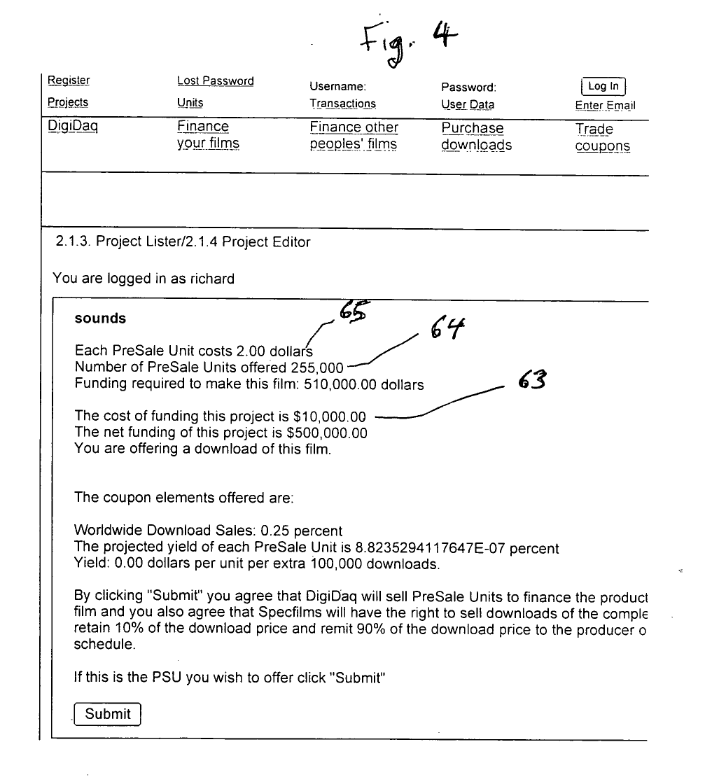

In FIG. 3 The wizard optionally creates coupons being offered for separate revenue streams associated with various ancillary markets. The wizard asks for the name of the project 60, the amount of funding required 61 and, the coupon specifications 62, which, in this case, is the percentage of worldwide download sales that the Producer is willing to share with holders of the DU coupons. In FIG. 4, when the Producer inputs the amount of funding required, for example, $500,000, and the percentage of revenue offered, for example, 25% of worldwide download sales, the wizard calculates the fee 63, which could vary depending on the project or other factors but is, for example, 2%, that the system will receive upon completion of funding and the number of DUs that must be offered to raise that money. The wizard then displays these numbers to the Producer, in this example, the fee 63 is $10,000 and the number of DUs 64 needed is 255,000 at $2.00 each 65. The wizard also displays the projected yield percentage for each DU, taking into account System fees of, for example, 10% of download sales, and the share of the revenue stream the holder will receive for each coupon for a certain number of deliverables sold, including a projected blended yield which is a function of all ancillary coupon revenue streams, after financing is complete. The wizard also gives the Producer the option of accepting these numbers, or entering a new set. If the Producer opts to enter a new set of numbers, the cycle continues until the Producer is satisfied with the deal offered to prospective DU purchasers.

Alternatively, the Producer can create one or more DUOs on the System using a DUO template without the aid of the software wizard. After the Producer chooses a name for the project and optionally provides a short description, the system allows for the creation of a DUO. Once the Producer has created a DUO, optionally providing a name, a short description, and a time constraint for this object, the System allows the creation of a DU component. To create the DU component, the Producer has the option of providing a name, a short description, and a time constraint, and must choose a component type from among deliverable, coupon, or auxiliary. If the type selected is deliverable or auxiliary, the name and description are sufficient to describe the component. However, if the type selected is coupon, the Producer is prompted to designate a revenue stream and a percentage of the revenue stream.

The revenue stream can be primary, for example, worldwide download sales, or ancillary, such as domestic box office, DVD sales, action figure licensing, or any other revenue stream that can be associated with the project, and the percentage associated with either primary or ancillary revenue streams can be anywhere from 0 to 100 percent. The percentage of the designated stream is the amount of this DU component that the Producer is willing to share with holders of the DU coupons. The Producer can enter multiple DU components of any or all types. The software calculates the fee that the System will receive upon completion of the sales of these DUs and the number of DUs that must be offered to raise that money. The System provides these numbers to the Producer and also provides the projected yield percentage for each DU and the amount of revenue the holder will receive for each coupon for a certain number of deliverables sold after production is completed and sales begin of downloads corresponding to coupons and auxiliaries. The wizard also displays the projected yield percentage for each associated DU coupon; as per the revenue stream the coupon holder will receive for each coupon held for each download sold, including a projected blended yield which is a function of all ancillary coupon revenue streams. The System software gives the Producer the option of editing the data provided until the Producer is satisfied with the deal offered to prospective DU purchasers. The System software also gives the Producer the option of entering more than one DU and multiple new DUs associated with it. The Producer is given the option of activating or deactivating complete DUs or individual components associated with DUs at this point or at any time prior to the time that the DU is completely funded.

As a final alternative, a Producer can request that the System Administrator, as the agent of the Producer, create DUOs on their behalf and at the discretion of the System. There may be a fee associated with this service.

In one aspect of the invention, a Producer may offer separate DUs to finance different aspects of the project. For instance where the Producer's project is a film production, s/he may offer DU1 to finance the shooting stage of the film, while offering DU2 for the distribution and marketing portions of the film project. The System also allows the Producers to be able to create custom DUs. For instance for films projects these custom DUs includes, but is not limited to, action figure licensing, product placement revenue, invitations to premieres, props from the films, autographed pictures, and cameos. Regardless of how many different DU types are offered in a project, the System starts each project funding at a certain percentage rate. In one embodiment, the System will start funding projects at 2%. This means that the first 2% of DUs pre-sold go to cover the Systems costs. It is understood that this percentage rate can be varied by the System, for instance depending on high much risk is associated with a project. The System allows the Producers the ability to modify the number of DU units they want to offer. The System will adopt a first come-first serve policy for the purpose of motivating Consumers to make their DU reservations early.

In one aspect of the invention, a Producer may offer separate coupons that correspond to different ancillary markets being pre-sold by the Producer. For instance, in one embodiment Producer can offer Coupon 1 tied to downloads, and Coupon 2 might apply to theatrical box office, cable sales, foreign, etc. Coupon 3 might apply to, but are not limited to, action figure licensing, product placement revenue, or the like. The combined, projected blended return for all Coupons tied to a project will be a number carried by the system as part of the suite of ratios and metrics tracked and displayed that reflect the overall trends within the resulting economy of having many Projects simultaneously participating in Primary Auctions.

The different DUs associated with any one project could be issued at once or could be issued as the production of the project progresses. If issued all at once, vested DUs would become less speculative as the film approaches completion.

Processing of the DUO by the System Administrator

Before the Producer accepts the deal, the System informs the Producer of the terms of the agreement between the Producer and the System. This includes rights and responsibilities of both parties both before and after the funding is completed. This agreement also details the participation that the System will have in exploiting other revenue streams that are generated by the project. These revenue streams include, but are not limited to, domestic and foreign theatrical release, DVD sales and rental, and action figure licensing. The Producer must agree to these terms prior to listing the project and its associated DUs.

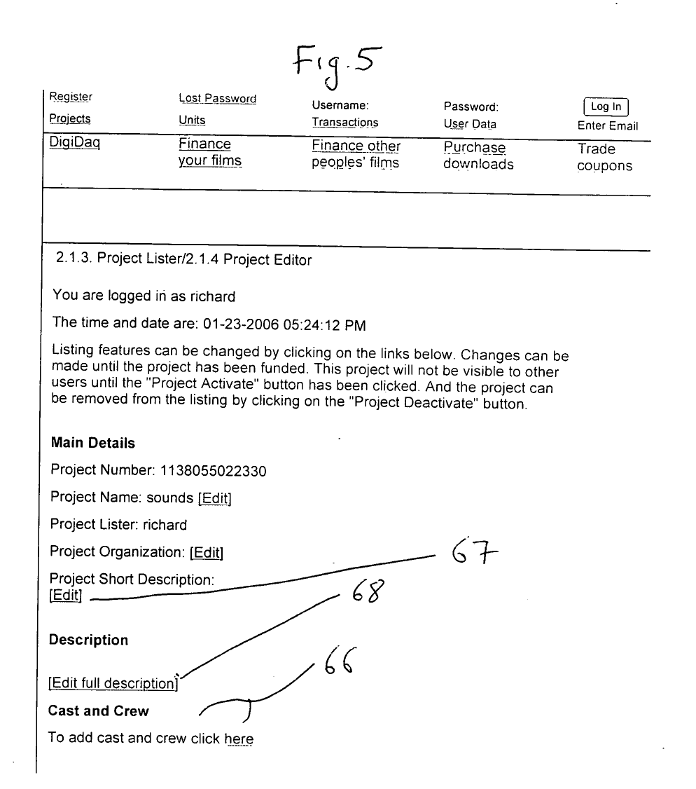

In FIG. 5, after the Producer accepts the deal, the System prompts the Producer to add and change project information, including the name of the project, the attached cast or crew 66, and both short 67 and long 68 descriptions. The Producer can also change the terms of the deal offered in any or all DUs at this point and, even after the DU is made available to Consumers, up until the time that the deal is fully funded. Once satisfied with the description, the Producer clicks an activate button to make the project available to potential DU Consumers. Note that changes made at this pre-funding stage may not be visible to potential DU Consumers; in contrast changes made during the funding stage may be visible to potential Consumers.

After a deal has been accepted by the Producer, the detail information can be accessed and modified, if necessary, by an Administrator using the System administration software. This software is an application that provides the operator or administrator with many process functions, among them the ability to rate the project on a letter scale (AAA-F as well as Unrated) and comment on its merits. This rating and comment are made available to potential DU Consumers in several ways, for example, via email or other data feeds. The rating may also be combined with other detail information such as projected yield so that disparate projects can be evaluated against each other.

The System Administrator, as part of processing the DUO, will give each Project DUO an independent rating depending on various facts including, but limited to, prior projects completed by the Producers and members of her/his production team. Having evaluated the deal unit offering, the System Administrator will 53, will continue the process and assign to the Project a viability rating 54, and then offer the Project to prospective consumers via the System 58 (See FIG. 2).

In FIG. 2 the System Administrator will have a multitude of projects to process and rate because, other than new deal memos, the System Administrator will be reviewing and rating 56 deal memos that have since been modified by Producers 55. In one construction, the System Administrator will prioritize the process by primarily focusing only on projects with the highest acceptance rate by Consumers. The System will make these modified DUOs, like the original DUOs, immediately accessible on its web site 58. Consumers accessing the System web site can then react to such modified projects by doing nothing, canceling, or buying more DUs in the modified project.

In one embodiment of the invention, all DUs offered on the System in the film category will have a master DU price (a price determined by the System Administrator). However, Projects within a different Project Category from films, for example, games, may have another master DU price associated with them. The System Administrator, but not the Producer, has the ability to change the master price for DUs, for instance, from $10 to $1 dollar, depending on market conditions. In one aspect of the invention, however, the overall DU price (as well as the coupon rate) may be adjustable to reflect the varying risks at different stages in the development of the project, or between different projects. Alternatively, the System might decide to lower the rate of DUs in projects that have not been purchased by Consumers after a certain length of time.

When a System administrator changes the price for all DUs in the System, only DUs for projects that have not been locked (that is, less than 100% of the available units have been ordered) are affected. There are two ways in which the affected DU offerings can be modified by changing the price. In the first way, the number of DUs available is changed in inverse proportion to the price change resulting in the same amount of funding for the project. In the second, the number of DUs is unchanged, resulting in a directly proportional change in the amount of funding sought. If the number of DUs is changed, the System has the option of changing the number ordered in Consumer accounts proportionally, or leaving the number unchanged. The Consumer has the ability to return any or all ordered units any time up until the DU offering is locked.

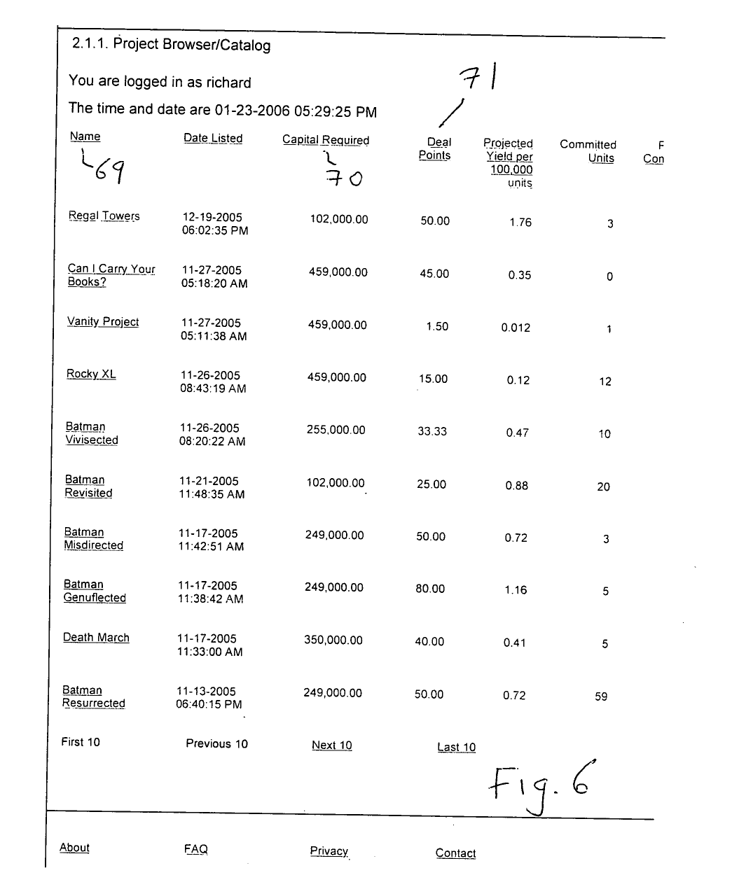

Once the project is activated and reviewed by the System Administrator, it is displayed by the System. Such displays can then be accessed by Consumers in the main project listing which is sorted by default by last activated project first. In FIG. 6, Consumers can select several different sort orders, including alphabetical by project name 69, amount of funding 70 required, percentage of revenue stream offered 71, in order to help rate the viability of various projects.

Consumers can access the display of project details stored in the database for any project in the listing. The detail includes all information uploaded by the Producer as well as any DU information available. The detail contains information on all DUs and DU components associated with the project so that Consumers can determine the projected revenue stream or streams offered. This allows Consumers to evaluate the financial return potential of the project and the DUs offered and compare this information with that of other projects and DUs. The financial return potential can result in the Consumer effectively receiving a discount or rebate on the cost of a DU or making a profit on the purchase of a DU. The detail also shows the Administrator's ratings and comments, if any. The detail also offers Consumers the opportunity to rate and comment on projects and displays these, if any, as well. Consumers are offered an opportunity to order the DU displayed by this function.

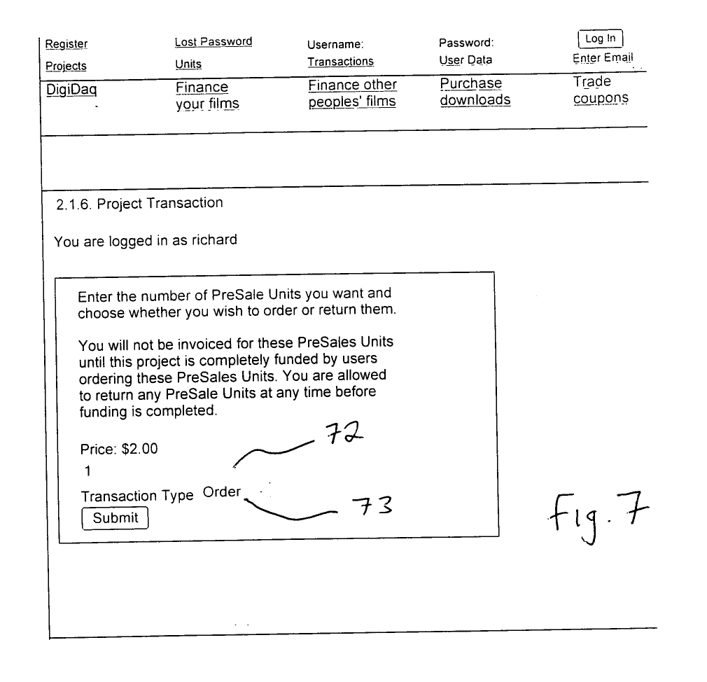

In FIG. 7, Consumers can order a DU by accessing the transaction function of the System software. The transaction function offers the Consumer a chance to enter the number of DUs they are interested in 72 and whether they wish to order DUs 73 or return to the pool DUs that they ordered previously. Once the Consumer submits the transaction, the System determines if the order (or return) can be accepted. If the transaction is accepted, the Consumer is prompted to confirm the transaction details. If the Consumer confirms the transaction, the transaction is processed and the Consumer is notified immediately (and optionally via email). Consumers are not invoiced or charged for any DUs ordered until the DU is fully subscribed. Thus, before this point the Consumer can review their decision to hold this particular DU, or to release it, and/or to buy other project DUs.

DU order and return data is stored in a transaction log so that Producers, Consumers, and Administrators can track Consumer interest in DUs associated with a project.

Project Review by Producers

Project DU detail information can be reviewed by the Producer using the System. DU information on the System includes, but is not limited to, project name, project description, personnel attached to the project, and project documentation, DU name, DU description, and other details of the DU offering. DU information also includes information pertaining to all separable components of the DU. Upon review of the DU information, Producers can choose to modify, or not modify, the DU at any time until 100% or greater (i.e., oversubscription value to be determined by the Administrator, to cover the case of Consumers who do not pay) of the funding for the project is reached.

Any modifications to the DUO made by the Producer are tracked in a project detail log so that Consumers, Administrators, and Producers themselves can track the status of the project over time. The changes may optionally be communicated to Consumers in email or other form. Upon obtaining this information, the Consumers can decide to review their decision to hold, release, or select further DUs. Consumers can implement their decisions using a simple on line registration forms found on the System.

Alternatively, DUOs changes can also be tracked by Consumers, administrators, and Producers using the DU component log. The DU coupon component contains a named revenue stream, such as worldwide download revenue, a percentage, and a time constraint. The percentage is the portion of the named revenue stream allocated to the holder of the each DU coupon over the referenced time constraint. The time constraint can be of any length up to legal life of the project. A short time constraint could be used to compensate coupon holders for, say, opening night or weekend revenues. Time constraints could also be used to distribute the same revenue streams over time, for example, coupons could cover first year worldwide download revenues, second year worldwide download revenues, and so on.

Thus, Consumers can monitor the project detail information log, the DU log, and the DU component detail log in order to review their decision to either hold, release, or select more DUs. Consumers can also monitor the transaction log to determine growing or waning interest in the community.

By monitoring the transaction log to determine the rate at which their projects are funding, a Producer can review his decision to modify or not-modify his Project DUO. If the Producer decides that the rate of funding needs to be increased, they can increase the percentage of the revenue streams associated with the DU coupon. Producers can also extend the time period that the coupon covers. Both of these actions will increase the potential revenue generated by this instruments and should increase Consumer interest. Producers can also add coupons sharing other revenue streams to existing DUs. This should also increase potential revenue and Consumer interest.

Alternatively, if Producer decides that the rate of funding is more than adequate, the Producer can decrease the percentage of the revenue streams associated with the DU coupon. Producers can also shorten the time period that the coupon covers. Both of these actions will decrease the potential revenue generated by these instruments and should decrease Consumer interest. However, this can increase the revenue retained by the Producer after the project has been released. Producers can also remove coupons sharing other revenue streams from existing DUs. This should also decrease potential revenue to Consumers and therefore Consumer interest, while increasing potential Producer revenue. There are several reasons that a Producer may want to slow the rate of funding, among them, a potential deal with an outside source of funding, interest from established talent, and interest from a traditional Producer or other outside purchaser.

Moreover, the Producer or the System may remove the entire project or a particular DU or even a component or components of a DU from the list of DUs that can be ordered by Consumers. Consumers holding DUs that have been removed for a project has not been locked may still return those DUs or may hold onto these in the event that the DU is reinstated. Consumers holding DUs that have been removed for a project has been locked or even funded may be entitled to compensation from the Producer as well as or in addition to a refund.

If the changes that the Producer makes to the project affects the amount of funding required, the Producer can enter the new amount of funding needed into the System software. The System software then recalculates the fee, which could vary depending on the project or other factors but is, in this example, 2%, that the system will receive upon completion of funding and the number of DUs that must be offered to raise that amount of funding.

Alternatively, the Producer upon review of the DU information displayed on the System may simply decide not to modify his current DUO.

DUs can be ordered by Consumers for projects until 100% or more (i.e., a variable percentage of oversubscription determined by the Administrator to cover the case of Consumers who do not pay) of the funding for the project is reached. Before this point, Consumers who are holding these unsecured-DUs in their accounts can return any or all of at any time prior to this point have been reached. When the System's software determines that the requisite numbers of DUs have been ordered, the System closes the auction. At this point all holders of these DUs are secured, and the Consumers invoiced. As an alternative, Consumer accounts with a cash balance can be debited automatically. Also at this point, the System deducts the funding fee, which could vary depending on the project or other factors but is, in this example, 2%, and disburses the funds to the Producer.

In one embodiment, the System will limit Consumers to the number of DUs they take part in during the Primary Auction to avoid Consumers from creating market imbalances with unsecured orders. Accordingly, the System will allow Consumers to reserve up to a certain number of Deal Units without a security of some type (the number and type of security to be determined by the System Administrator). Alternatively, the System may waive this requirement to Consumers who are subscribers of the System and to Consumers who maintain certain minimum cash balances in their portfolios.

Using System's Secondary Market Consumers that hold DU coupons and credits can now market list them for sale, purchase, or swap with other Consumers.

Consumers can list coupons for sale that were acquired by the purchase of a DU during the funding phase as well as re-list coupons that they had purchased previously on the System's secondary market. Consumers/potential sellers can sell any or all of the listed coupons by clicking on a “sell” link on the purchase offer detail page.

The Consumer may also want to access a listing form that is generated by the System software. This listing form displays the historical high and low selling price for the coupon, the last selling price for the coupon, and the historical volume of sales of the coupon to the Consumer. The holder is prompted by the System software to enter the quantity of coupons offered, the price desired, plus an optional time constraint for the offer, and to submit the offer to the System. Once the coupon holder submits the transaction, the System software displays a confirmation screen to the holder containing the details of the offer and asks the holder to confirm. If the holder confirms the offer it is posted to a coupon market browser. Alternatively, the System software may contain functionality to accept the transaction at a predefined or variable price.

Alternatively, Consumers/prospective purchasers who wish to purchase DU coupons can now list offers to buy on the System's secondary market. To do this, the prospective coupon purchaser accesses a listing form that is generated by the System software. The software optionally displays the historical high and low selling price for the coupon, the last selling price for the coupon, and the historical volume of sales of the coupon to the Consumer. The prospective purchaser is prompted by the System software to enter the quantity of coupons desired, the price offered, plus an optional time constraint for the offer, and to submit the offer to the System. The prospective purchaser may also be presented with optional payment information options at this time so that payment can be made automatically at the time that their purchase offer is accepted.

Once the potential purchaser submits the offer, the System software displays a confirmation screen to the purchaser containing the details of the offer and asks the purchaser to confirm. If the purchaser confirms the offer it is posted to a coupon market browser. Alternatively, the System software may contain functionality to accept the transaction at a predefined or variable price.

Consumers/potential purchasers can view the data in the coupon market browser, sorting be the coupon or offer data including, but not limited to, price, start or end of offer date and time. Consumers/potential purchasers can view offer details by clicking on the listing.

Consumers/potential purchasers can purchase any or all of the listed coupons by clicking on a “purchase” link on the sale offer detail page. There, Consumers/potential purchasers will be prompted to provide several payment options, such a deliverable card or debit account information. If payment is approved, the number of coupons is transferred from the account of the Seller to the account of the purchaser. The System deducts the commission (which may be shared by the System with the Producer), if any, and deliverables the balance to the account of the Seller. The Consumer/potential purchaser has a finite time period to respond and if payment is made and approved, these coupons are transferred from the account of the Seller to the account of the purchaser.

Consumers who have listed their coupons to sell or have offered to buy can cancel their listings at any time up until the offer has been acted on by a Consumer who wishes to complete the transaction.

Consumers can chose to pre-purchase the non-DU-based credit (generally a download) of the funded project in anticipation of when the project is released. The revenue for these sales goes into the revenue split that was chosen for the coupon component of the DU. These sales do not include a coupon. These sales may be deferred until the credit deliverable is completed, but may alternatively be invoiced or charged immediately by the System, but with the funds held by the System and not remitted to the Producer until the credit deliverable is finished. The System may take a percentage of these sales as a transaction fee or a commission. These sales may be refundable if the non-DU credit deliverable is not forthcoming, unlike the credit deliverable component of the DU.

In one construction of the invention, Subscribers of the System can earn extra non-DU credit deliverables in a variety of ways including, but not limited to, filling out surveys for Producers. The System can also allow Producers to discount film, game, and music deliverable downloads that been available on the System for length of time in order to stimulate more sales.

Consumers that hold Credits, either acquired by the purchase of DUs in the funding stage or by purchase in the post funding phase, can now list them on the System's secondary market for exchange with other Consumers. Consumers can also re-list deliverables that they had purchased previously on the System's secondary market. To do this, the deliverable holder accesses a listing form that is generated by the System software that displays a list of e deliverables that are suitable for exchange so that the Consumer can select one or more of the deliverables are acceptable in trade and optionally, the maximum amount of each deliverable that will be accepted. This list is generated from the entire catalog of deliverables in the System. The deliverable holder is prompted by the System software to enter the quantity of deliverables offered, plus an optional time constraint for the offer, and to submit the offer to the System.

If cash sales of deliverables are allowed in the System's secondary market, the System software may also or alternatively display the selling price of the deliverable and the deliverable holder is prompted by the System software to enter the quantity of deliverables offered, plus an optional time constraint for the offer, and to submit the offer to the System. If price setting of deliverables is allowed in the System's secondary market, the System also prompts the deliverable holder for the desired selling price.

Once the deliverable holder submits the transaction, the System software displays a confirmation screen to the holder containing the details of the offer and asks the holder to confirm. If the holder confirms, the offer it is posted to a deliverable market browser. Alternatively, the software may contain functionality to accept the transaction at a predefined or variable price.

Alternatively, Consumers who wish to acquire deliverables can now list offers to swap/exchange using the System's secondary market. To do this the, the prospective deliverable acquirer accesses a listing form that is generated by the System software. The System software displays a list of deliverables that the prospective acquirer currently holds so that the prospective acquirer can select the deliverables that would be acceptable in exchange. The deliverable acquirer is prompted by the System software to enter the quantity of downloads requested, plus an optional time constraint for the offer, and to submit the offer to the System.

If cash sales of deliverables are allowed by the System, the software optionally displays the selling price of the deliverable to the prospective acquirer. If price setting of deliverables is allowed, the System software optionally displays historical high and low selling price for the deliverable, the last selling price for the deliverable, and the historical volume of sales of the deliverable. The prospective acquirer is prompted by the System software to enter the quantity of deliverables desired, the price offered, plus an optional time constraint for the offer, and to submit the offer to the System. The prospective acquirer may also be presented with optional payment information options at this time so that payment can be made automatically at the time that their purchase offer is accepted.

Once the potential acquirer submits the offer, the System software displays a confirmation screen to the acquirer containing the details of the offer and asks the purchaser to confirm. If the acquirer confirms the offer it is posted to a deliverable market browser. Alternatively, the System software may contain functionality to accept the transaction at a predefined or variable price.

Consumers can view the data in the deliverable market browser, sorting by offer data including, but not limited to, project name, quantity, start or end of offer date and time. Consumers can view offer details by clicking on the listing.

Consumers can acquire any or all of the listed deliverable deliverables by clicking on an “exchange” link on the deliverable exchange offer detail page. There, Consumers will be prompted to select the deliverable or deliverables that are being offered, or in the case of a financial transaction will be presented several payment options, such as credit card or debit account information. If the transaction or payment is approved, the deliverables are transferred between the accounts of the parties to the transaction. The System may also charge one or both of the parties a commission or transaction fee (which may be shared by the system with the Producer). In the case of a financial transaction, the System deducts the commission (which may be shared by the system with the Producer), if any, and deliverables the balance to the account of the seller.

Using the System, Consumers can also list which of their Credits they want to swap with other Consumers. Consumers can also provide any or all of the requested credit deliverables by clicking on an “exchange” link on the purchase offer detail page. The System will provide the providing Consumers with a prompt to select the Credit Deliverables or Deliverables desired in exchange, or in the case of a financial transaction, several payment options. If the exchange is approved, Credit Deliverables are transferred between the accounts of both parties. The System may also charge one or both of the parties a commission or transaction fee (which may be shared by the system with the Producer). In the case of a financial transaction, the purchasing Consumer has a finite time period to respond and if payment is made and approved, the number of Credit Deliverables is transferred from the account of the seller to the account of the purchaser. The System deducts the commission (which may be shared by the system with the Producer), if any, and delivers the balance to the account of the seller.

Consumers who have offered to sell or have offered to buy Credit Deliverable can cancel their offer at any time up until the offer has been acted on by another Consumer who wishes to complete the transaction.

Consumers that hold DU auxiliaries can now list them on the System's secondary market for sale to or exchange with other Consumers. Consumers can list auxiliaries that were acquired by the purchase of a DU during the funding phase as well as re-list auxiliaries that they had purchased previously on the System's secondary market. Consumers can also list auxiliaries that they have already taken delivery of. To do this, the holder accesses a listing form that is generated by the System software. This form contains a list of deliverable deliverables, coupons and auxiliaries that are suitable for exchange so that the Consumer can select one or more that are acceptable in trade and optionally, the maximum amount of each that will be accepted. This list is generated from the entire catalog of salable and exchangeable components in the system. The System software optionally displays the historical high and low selling price for the auxiliary, the last selling price for the auxiliary, and the historical volume of sales of the auxiliary to the Consumer. The holder is prompted by the System software to enter the quantity of auxiliaries offered, the price desired or the acceptable exchange components or both, plus an optional time constraint for the offer, and to submit the offer to the System.

Once the auxiliary holder submits the transaction, the System software displays a confirmation screen to the holder containing the details of the offer and asks the holder to confirm. If the holder confirms the offer it is posted to an auxiliary market browser. Alternatively, the System software may contain functionality to accept the transaction at a predefined or variable price.

Alternatively, Consumers who wish to purchase or otherwise acquire DU auxiliaries can now list offers to buy on the System's secondary market. To do this the, the prospective acquirer accesses a listing form that is generated by the System software. This form contains a list of deliverable deliverables, coupons and auxiliaries that are suitable for exchange so that the Consumer can select one or more that the Consumer is willing to trade and optionally, the maximum amount of each that is offered. This list is generated from the salable and exchangeable components in the account of the prospective acquirer. The System software optionally displays the historical high and low selling price for the auxiliary, the last selling price for the auxiliary, and the historical volume of sales of the auxiliary to the Consumer. The prospective acquirer is prompted by the System software to enter the quantity of auxiliaries desired, the price offered, plus an optional time constraint for the offer, and to submit the offer to the System. The prospective acquirer may also be presented with optional payment information options at this time so that payment can be made automatically at the time that their offer is accepted.

Once the prospective acquirer submits the offer, the System software displays a confirmation screen containing the details of the offer and asks the acquirer to confirm. If confirmed, the offer is posted to an auxiliary market browser. Alternatively, the System software may contain functionality to accept the transaction at a predefined or variable price.

Consumers can view the data in the auxiliary market browser, sorting by offer data including, but not limited to, price, start or end of offer date and time. Consumers can view offer details by clicking on the listing.

Consumers can purchase any or all of the listed auxiliaries listed for sale by clicking on a “purchase” link on the offer detail page. There, Consumers may be prompted to provide several payment options, such a deliverable card or debit account information. If payment is approved, the auxiliaries are transferred from the account of the seller to the account of the purchaser. The System deducts the commission (which may be shared by the System with the Producer), if any, and deliverables the balance to the account of the Seller. Consumers can acquire any or all auxiliaries listed for exchange by clicking on an “exchange” link on the detail page.

Consumers can sell any or all of the listed auxiliaries by clicking on a “sell” link on the purchase offer detail page. The System will provide the purchasing Consumers with several payment options, such a deliverable card or debit account information. The purchasing Consumer has a finite time period to respond and if payment is made and approved, the auxiliaries are transferred from the account of the seller to the account of the purchaser. The System deducts the commission (which may be shared by the System with the Producer), if any, and deliverables the balance to the account of the Seller.

Consumers who have offered to sell, buy, or exchange auxiliaries can cancel their offer at any time up until the offer has been acted on by Consumer who wishes to complete the transaction.

Once the project is released, all holders of all DU components are notified.

Periodic payments are deliverable to DU coupon holders based on sales starting when download purchases are paid for by Consumers had purchased downloads prior to or after the project has been released.

The System Administrator is able to code Projects and DUs according to their particular status in the System. In one construction of the invention, the System will issue a DU code of 1 when the DU is active (available for order or return); a code of 4 when the last DU is ordered and the DU locked (current 100% or 125% of the allotment). At this point the System will send out email invoices for the DUs to the Consumers. The Consumers will have to come back to their accounts (for instance, by clicking on a link in the email) and pay for the DU. Alternatively, an ‘e-wallet’ system used on gambling web sites could be used as a payment method by the System. In one embodiment of the invention, the System charges a subscription which gives the Consumer unlimited DUs without a charge. Finally, when 100% of the DUs are paid for, the System automatically changes the DU code to 8 to signify that the DU is vested. The System Administrator will at this point will send the money to the Producer.

The System will de-list coupons, from its web site, when interest in them has eventually dried up. In one embodiment of the invention, the System Auction process has the ability to buy into its own inventory coupons that receive little or no attention. Later, the System is able to re-sell them.

Revenue for the System

The System takes a fee, currently set at 10%, of all downloads sold on the site. This fee can be a flat amount, percentage or formula.

The System may engage in selling projects to outside vendors.

The system engages in developing ancillary revenue streams attached to Coupons that Producers offer via the Primary Auction system that embeds Coupons into Deliverables, which in turn are pre-bought by Consumers; where the System may charge a fee for such a service.

In one construction, the System will derive its revenue using subscriptions. In this construction, the System offers certain benefits to Consumers who have subscribed to the System. The benefits to subscription include, but are not limited to, not being required to pay additional fees to purchase more than the standard quota of DUs for any given Project; subscriber Producers not being limited to the number of Projects they can list without additional costs; subscriber Consumers being able to ‘earn’ extra deliverables in a variety of ways, including but not limited to filling out surveys for Producers; subscriber Consumers being able to download movies multiple times; subscriber Consumers being offered access to certain data used for research; subscriber Consumers being able to reinvest dividends from their coupons or trades; subscriber Consumers being offered email contact with Producers (who choose this option); subscriber Producers being able to get their Projects ‘rated’ by the System Administrator; and subscriber Producers being able to pay less to list their Projects compared with non-subscriber Producers. In another aspect, the System Administrator will reinvest a percentage of subscriber income (to be determined by the System Administrator) into buying up certain Project DUs (the type of Project also to be determined by the System Administrator). This, in effect, stimulates the System ‘economy’ by getting more Project deals completed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

### EXAMPLES

### Example 1

Producer A offers 10,000 DUs at $10 (where the coupon rate is 0.004%) for his Film Project in an auction, but not enough Consumers offer to buy. In a traditional Dutch auction process, Producer A can lower the DU price from $10 to $5 to encourage more offers. However, in an embodiment of this invention, Producer A cannot lower his DU price but instead can stimulate attention to his project by increasing the coupon rate from 0.0004 to 0.0005%. By altering the DU coupon to 0.0005%, the Producer has aligned his interest in the Project. Similarly, when Consumers see the changes made by the Producer to the Project DU, they will align their interest by selecting more Project DUs created by this Producer. In this process of aligning of interests, the object of the auction-DU-changes. Alternatively, the Producer could have aligned his interest adding more talent (i.e., a well-known director or actor) to his Project, while leaving the coupon rate unchanged.

### Example 2

A Consumer takes down 10 DUs in a film project. The film project obtains all of its funding, and the 10 DUs are transferred into the Consumer's account. At this point the DUs are split into 10 download deliverables and 10 coupons. The Consumer can at this point sell off these 10 coupons on the System's secondary auction market or decide to hold onto to them. Alternatively, the Consumer may buy more coupons on the System's secondary auction market. Because the Consumer has 10 download deliverables, s/he can download the same movie, for instance, when completed, ten times. Alternatively, the Consumer holding these 10 download deliverables may exchange these download deliverables, using the System, for download deliverables in another completed movie. However, in one embodiment the System may impose restrictions on exchanging deliverables, for instance by only allowing Consumers a 50% discount in another film, rather than a straight exchange; in another construction of the invention, the System may limit the exchange of deliverables to apply only to films in System that are available for more than a certain length of time.

### Example 3

A Project listed on the System has a $100,000 financing requirement and is broken down into 20,000 DUs priced at 5 dollars each. In one embodiment, the System performs a mass debit when all 20,000 (100%) DUs have been reserved. In another embodiment, the System waits until 25000 (125%) of the DUs have been reserved in order to account for bad credit cards of some Consumers.

### Example 4

The DU can be used to sell a part or the whole Project in one or more stages. For example, in one embodiment where the Project is a film, a DU of $1 and a quantity of 10,000 and 20% of gross sales on US deliverable downloads could be used to finance the pre-production phase 1. A DU of $2 and a quantity of 20,000 and 20% of gross profits on domestic downloads of 30% could be used to finance pre-production phase 2.

### Example 5

A Producer seeks $200,000. The Producer pre-sells on the System 100,000 DUs at $2 a piece with the proviso that 50% of gross internet sales will be distributed to coupon holders on a pro-forma basis. Thus, for every 100,000 copies of the film sold on the System above the initial 100,000 copies that were pre-sold to fund the project, $100,000 will be divided, amongst the consumers who pre-bought copies, for a net return to free coupon holders of $1 per each coupon.

I claim:

1. A method for speculating on projects on the internet, comprising the steps of:
Creating a DUO for a project on a System,
Processing of said DUO by a System Administrator,
Displaying of said DUO by said System,
Aligning of interests for a plurality of DUs of the project, associated with said DUO, by a Producer and a Consumer, and
Closing of auction for said plurality of DUs of the Project by said System Administrator.

2. The method for speculating on projects on the internet of claim 1, further comprising listing of a plurality of DU components by Consumer on a Secondary Market System.

3. The method for speculating on projects on the internet of claim 1 wherein the aligning of interests step comprises of selecting of DUs by the Consumer, monitoring of interest to purchase said DU by the Producer, reviewing of said DUO by the Producer, and reviewing of decision to hold said DU by Consumer.

4. The method for speculating on projects on the internet of claim 1 wherein the aligning of interests step comprises of monitoring, by Consumers, of modifications made to the DUO by Producers; selecting of DUs, by Consumers of the DUO; monitoring of interest, by the Producer, to purchase said DU by the Producer, and reviewing of said DUO, by the Producer, and reviewing of decision to hold said DU by Consumer.

5. The method for speculating on projects on the internet of claim 2 wherein the aligning of interests step comprises of selecting of DUs by the Consumer, monitoring of interest to purchase said DU by the Producer, reviewing of said DUO by the Producer, and reviewing of decision to hold said DU by Consumer.

6. The method for speculating on projects on the internet of claim 2 wherein the aligning of interests step comprises of monitoring, by Consumers, of modifications made to the DUO by Producers; selecting of DUs, by Consumers of the DUO; monitoring of interest, by the Producer, to purchase said DU by the Producer, and reviewing of said DUO, by the Producer, and reviewing of decision to hold said DU by Consumer.

7. A method for speculating on projects on the internet, comprising the steps of:
Creating a DUO for a project on a System,
Processing of said DUO by a System Administrator,
Displaying of said DUO by said System,
Aligning of interests for a plurality of DUs of the project, associated with said DUO, by a Producer and a Consumer,
Closing of auction for said plurality of DUs of the Project by said System Administrator, and
Listing of a plurality of DU components by Consumer on a Secondary Market.

8. A method for speculating on projects on the internet, comprising the steps of:
Creating a DUO for a project on a System,
Processing of said DUO by a System Administrator,
Displaying of said DUO by said System,
Aligning of interests for a plurality of DUs of the project, associated with said DUO, by a Producer and a Consumer,
wherein the aligning of interests step comprises of selecting a plurality of DUs by the Consumer, monitoring of interest to purchase said DU by the Producer, reviewing of said DUO by the Producer, and reviewing of decision to hold said DU by Consumer, and
Closing of auction for said plurality of DUs of the Project by said System Administrator.

9. A method for speculating on projects on the internet, comprising the steps of:
Creating a DUO for a project on a System,
Processing of said DUO by a System Administrator,
Displaying of said DUO by said System,
Aligning of interests for a plurality of DUs of the project, associated with said DUO, by a Producer and a Consumer,
wherein the aligning of interests step comprises of monitoring, by Consumers, of modifications made to the DUO by Producers; selecting of DUs, by Consumers of the DUO; monitoring of interest, by the Producer, to purchase said DU by the Producer, and reviewing of said DUO, by the Producer, and reviewing of decision to hold said DU by Consumer, and
Closing of auction for said plurality of DUs of the Project by said System Administrator.

10. A System for speculating on projects on the internet comprising:
an internet-based information component connected to the internet for:
Creating a DUO for a project on a System,
Processing of said DUO by a System Administrator,
Displaying of said DUO by said System,
Aligning of interests for a plurality of DUs of the project, associated with said DUO, by a Producer and a Consumer,
Closing of auction for said plurality of DUs of the Project by said System Administrator, and
Listing of a plurality of DU components by Consumer on a Secondary Market.

11. A System for speculating on projects on the internet of claim 10 wherein the System is configured so that the DUO comprises of a credit, coupon and auxiliary.

12. A System for speculating on projects on the internet of claim 11 wherein the System is configured so that the System Administrator has a plurality of job functions.

13. A System for speculating on projects on the internet of claim 12 wherein the System is configured so that the DU value for a project is determined by the System Administrator.

14. A System for speculating on projects on the internet of claim 13 wherein the System is configured so that a coupon value is determined a Producer of said DUO.

15. A System for speculating on projects on the internet of claim 14 wherein the System is configured to issue a plurality of DU types in a project.

16. A System for speculating on projects on the internet of claim 15 wherein the System is configured to display the DUO in terms of a project rating.

17. A System for speculating on projects on the internet of claim 16 wherein the System is configured to divide a DU in a project, after a Consumer has purchased the DU, into a credit and a coupon portion.

18. A System for speculating on projects on the internet of claim 17 wherein the System is configured so that the credit can be used to receive a copy of a completed deliverable.

19. A System for speculating on projects on the internet of claim 18 wherein the System is configured so that one Project credit can be used to exchange with a credit portion of a different Project.

20. A System for speculating on projects on the internet of claim 19 wherein the System is configured to allow the coupons to be auctioned by said System.

21. A System for speculating on projects on the internet of claim 20 wherein the System is configured to limit the total number of DUs that may be sold to any one Consumer.

22. A System for speculating on projects on the internet of claim 21 wherein the System is configured so that a completed DU is selected from a group consisting of films, music, computer and video games.

23. A System for speculating on projects on the internet comprising:
an internet-based information primary component connected to the internet for:
Creating a DUO for a project on a System,
Processing of said DUO by a System Administrator,
Displaying of said DUO by said System,
Aligning of interests for a plurality of DUs of the project, associated with said DUO, by a Producer and a Consumer,
Closing of auction for said plurality of DUs of the Project by said System Administrator. and
listing of a plurality of DU components by Consumer on a Secondary Market,
wherein the System is configured so that the DUO comprises of a credit, coupon and auxiliary,
wherein the System is configured so that the System Administrator has a plurality of job functions,
wherein the System is configured so that DU value for a project is determined by the System Administrator.
wherein the System is configured so that a coupon value is determined a Producer of said DUO,
wherein the System is configured to issue a plurality of DU types in a project,
wherein the System is configured to display the project offering in terms of project rating,
wherein the System is configured to divide a DU offered in a project, after a Consumer has purchased the DU, into a credit and a coupon portion,
wherein the System is configured so that the credit can be used to receive a copy of a completed deliverable,
wherein the System is configured so that one Project credit can be used to exchange with a credit portion of a different Project,
wherein the System is configured to allow the coupons to be auctioned by said System,
wherein the System is configured to limit the total number of DUs that may be sold to any one Consumer, and
wherein the System is configured so that a completed DU is selected from a group consisting of films, music, and video games.
